(19) United States
(12) Patent Application Publication
(10) Pub. No.: US 2021/0206103 A1
(43) Pub. Date: Jul. 8, 2021

(54) AIR FLOW STRAIGHTENERS WITH SILENCER

(71) Applicant: HEWLETT-PACKARD DEVELOPMENT COMPANY, L.P., Spring, TX (US)

(72) Inventor: Kevin CARBONE, Vancouver, WA (US)

(73) Assignee: HEWLETT-PACKARD DEVELOPMENT COMPANY, L.P., Houston, TX (US)

(21) Appl. No.: 16/075,615

(22) PCT Filed: Jul. 27, 2017
(86) PCT No.: PCT/US2017/044140

§ 371 Date: Aug. 4, 2018

(51) Int. Cl. B29C 64/364; B33Y 30/00; F04D 29/66; F04D 29/54

(52) U.S. Cl. CPC B29C 64/364; F04D 29/541; F04D 29/664; B33Y 30/00

(57) ABSTRACT

An apparatus includes a fan, a flow straightener, and a silencer. The fan creates an air flow. The flow straightener directs the air flow from the fan. The silencer is directly coupled to the flow straightener and reduces noise of the air flow.

### BACKGROUND

Printing technologies may be used to create three-dimensional (3D) objects from data output from a computerized modeling source. For example, a 3D object may be designed using a computer program (e.g., a computer aided design (CAD) application) to generate a 3D model of the object, and the computer may output the data of the 3D model to a printing system capable of forming the solid 3D object. Solid free-form fabrication (or layer manufacturing) may be defined generally as a fabrication technology used to build a 3D object using layer by layer or point-by-point fabrication. With this fabrication process, complex shapes may be formed without the use of a pre-shaped die or mold.

### BRIEF DESCRIPTION OF THE DRAWINGS

FIG. 1A is a side view and FIG. 1B is a cross-sectional view illustrating one example of an air flow noise reducing apparatus.

FIG. 2 illustrates one example of an apparatus for cooling a component of a three dimensional (3D) printing system.

FIG. 3A is a front view and FIG. 3B is a back view illustrating one example of a 3D printing system.

FIG. 4 is a flow diagram illustrating one example of a method for moving air.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

Three dimensional (3D) printing systems may include fans for cooling components within the 3D printing systems. Two dimensional (2D) printing systems and other types of systems may also include fans for cooling components within the systems. The fans and/or the air flow generated by the fans may be noisy, which is disruptive to users of the 3D printing systems or others near the 3D printing systems. Accordingly, disclosed herein is an air flow noise reducing apparatus including a fan to create an air flow, a flow straightener to direct the air flow from the fan, and a silencer directly coupled to the flow straightener to reduce noise of the air flow. The flow straightener directs the air flow from the fan into the silencer, which includes a sound dampening material. The apparatus may be used, for example, to cool a lamp assembly and/or other components within a 3D printing system.

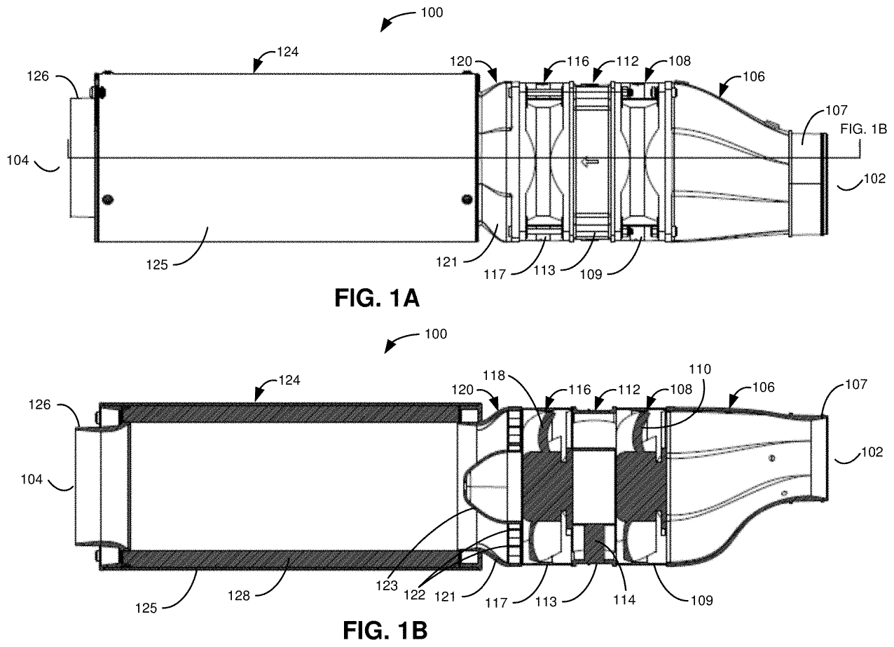

FIG. 1A is a side view and FIG. 1B is a cross-sectional view illustrating one example of an air flow noise reducing apparatus 100. Air flow noise reducing apparatus 100 includes an air inlet 102, an air outlet 104, a first fan 108, a stator 112, a second fan 116, a flow straightener 120, and a silencer 124. While air flow noise reducing apparatus 100 includes two fans, in other examples air flow noise reducing apparatus 100 includes a single fan or more than two fans.

Air inlet 102 is provided by a housing 106 directly coupled to first fan 108. Housing 106 may be press-fitted, crimped, bolted, or connected in another suitable manner to first fan 108. Housing 106 includes a connector 107 for coupling to an air duct. In this example, connector 107 has a smaller diameter than fan 108 such that housing 106 increases in diameter between connector 107 and first fan 108. In other examples, housing 106 may have other suitable shapes based upon the air duct to which connector 107 is to be coupled. Connector 107 may be press-fitted, crimped, bolted, or connected in another suitable manner to an air duct.

First fan 108 is an axial fan including a fan housing 109 and a propeller 110. Second fan 116 is also an axial fan including a fan housing 117 and a propeller 118. First fan 108 is directly coupled between housing 106 and stator 112 using fasteners or another suitable technique. Second fan 116 is directly coupled between stator 112 and flow straightener 120 using fasteners or another suitable technique. First fan 108 and second fan 116 create an air flow from air inlet 102 toward air outlet 104. In one example, first fan 108 and second fan 116 create an air flow between 100-140 CFM. Stator 112 is a fan coupler for co-rotating fans 108 and 116. Stator 112 includes a stator housing 113 and airfoils 114 to direct air from first fan 108 to second fan 116.

Flow straightener 120 includes a housing 121, a pattern of vanes 122, and a cone 123 aligned with the center of second fan 116. Vanes 122 extend between housing 121 and cone 123. In one example, vanes 122 are arranged in a hexagon pattern parallel to the air flow direction between air inlet 102 and air outlet 104. In other examples, vanes 122 may be arranged in other suitable patterns parallel to the air flow direction between air inlet 102 and air outlet 104, such as in a parallel plate pattern, a rectangular pattern, or a square pattern. The pattern of vanes 122 and cone 123 are aligned with silencer 124 to straighten and direct the air flow from first fan 108 and second fan 116 into silencer 124.

Silencer 124 includes a cylindrical housing 125 and a sound dampening material 128. In one example, housing 125 may be press-fitted, crimped, bolted, or connected in another suitable manner to flow straightener 120. In another example, silencer 124 is integral with flow straightener 120 such that silencer 124 and flow straightener 120 have a common housing 121/125. Housing 125 includes a connector 126 for coupling to an air duct. Connector 126 may be press-fitted, crimped, bolted, or connected in another suitable manner to an air duct. Sound dampening material 128 lines the inside of housing 125. Sound dampening material 128 may include fiberglass, a melamine based foam material, a flame retardant material, and/or another suitable material for reducing the noise of the air flow between air inlet 102 and air outlet 104.

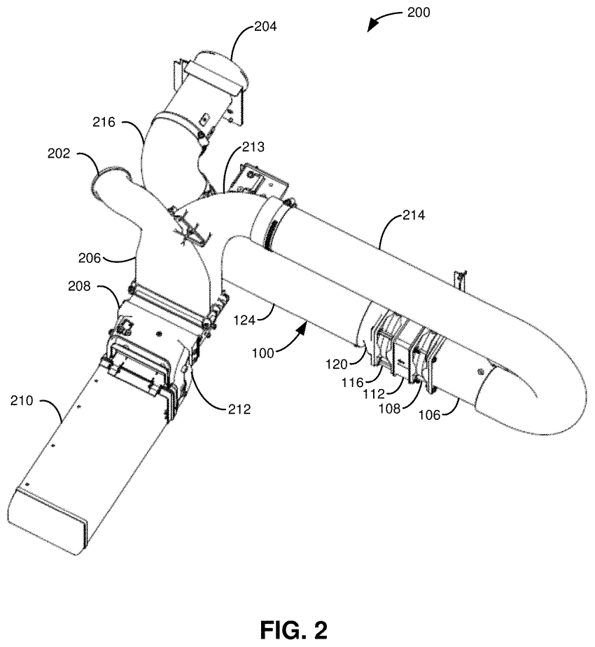

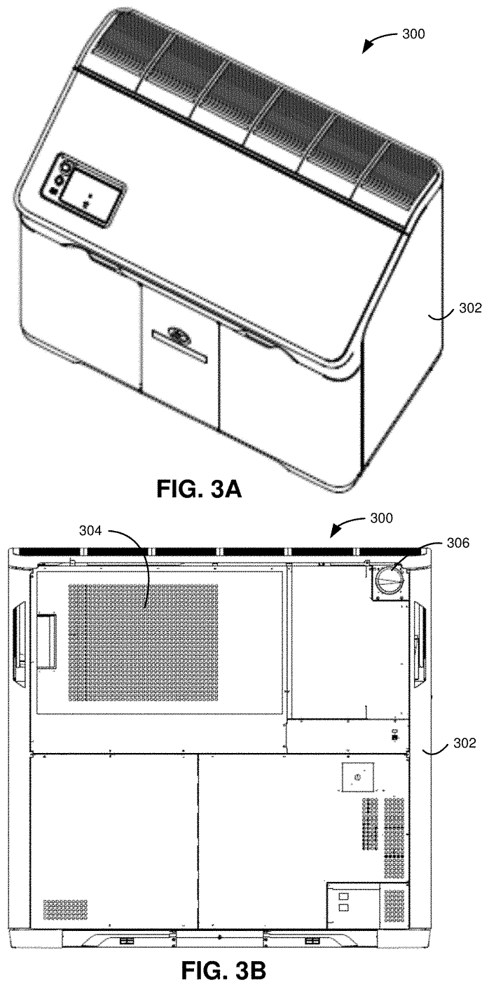

First fan 108, stator 112, second fan 116, flow straightener 120, and silencer 124 are linearly aligned and provide a compact air flow noise reducing apparatus 100. In one example, air flow noise reducing apparatus 100 reduces noise by 10-15 dB compared to an apparatus without flow straightener 120 and silencer 124. The noise reduction is achieved without any significant reduction in air flow. Air flow noise reducing apparatus 100 may be used in any suitable system where reducing noise due to a generated air flow is desirable, such as in a 3D printing system as will be described below with reference to FIGS. 2, 3A, and 3B.

FIG. 2 illustrates one example of an apparatus 200 for cooling a component of a 3D printing system. Apparatus 200 includes an air inlet 202, an air outlet 204, a lamp assembly 210, air ducts 206, 208, 212, 213, 214, and 216, and an air flow noise reducing apparatus 100. Air inlet 202 provides cool air to air duct 206. Air duct 206 is coupled to air duct 208, which is coupled to lamp assembly 210. Lamp assembly 210 is coupled to air duct 212, which is coupled to air duct 213. Air duct 213 is coupled to air duct 214, which in one example includes a flexible hose. Air duct 214 is coupled to the air inlet of air flow noise reducing apparatus 100. The air outlet of air flow noise reducing apparatus 100 is coupled to air duct 216, which exhausts heated air through air outlet 204.

Air flow noise reducing apparatus 100 was previously described and illustrated with reference to FIGS. 1A and 1B and includes an air inlet housing 106, a first fan 108, a stator 112, a second fan 116, a flow straightener 120, and a silencer 124. First fan 108 and second fan 116 create an air flow between air inlet 202 and air outlet 204. In this example, the air flow cools lamp assembly 210. Lamp assembly 210 may include fusing lamps for fusing powdered build material, such as plastic and nylon powders, metal powders, ceramic powders, and the like, to form 3D objects. In other examples, the air flow may cool other components of a 3D printing system.

FIG. 3A is a front view and FIG. 3B is a back view illustrating one example of a 3D printing system 300. Printing system 300 includes a housing 302 and internal components (not shown) for forming 3D objects. Housing 302 includes an air inlet 304 to receive cooler air and an air outlet 306 to exhaust warmer air. In one example, air inlet 304 includes an air filter. Printing system 300 includes a printer component (e.g., a lamp assembly as previously described and illustrated with reference to FIG. 2) that heats the cooler air. Printing system 300 also includes at least one fan to create an air flow between the air inlet 304 and the air outlet 306, a flow straightener to direct the air flow from the at least one fan, and a silencer directly coupled to the flow straightener to reduce noise of the air flow (e.g., an air flow noise reducing apparatus 100 as previously described and illustrated with reference to FIG. 1).

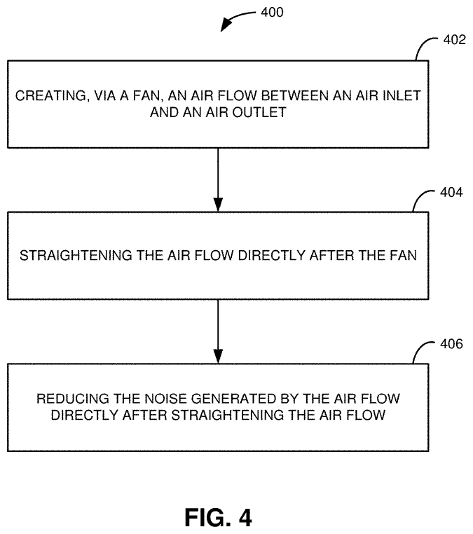

FIG. 4 is a flow diagram illustrating one example of a method 400 for moving air. At 402, method 400 includes creating, via a fan, an air flow between an air inlet and an air outlet. In one example, creating the air flow includes creating the air flow via a plurality of fans. At 404, method 400 includes straightening the air flow directly after the fan. At 406, method 400 includes reducing the noise generated by the air flow directly after straightening the air flow. Method 400 may also include cooling a component via the air flow. In one example, cooling the component includes cooling a lamp assembly of a 3D printing system.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. An apparatus comprising:
a fan to create an air flow;
a flow straightener to direct the air flow from the fan; and
a silencer directly coupled to the flow straightener to reduce noise of the air flow.

2. The apparatus of claim 1, wherein the fan, the flow straightener, and the silencer are linearly aligned.

3. The apparatus of claim 1, wherein the silencer comprises a sound dampening material.

4. The apparatus of claim 1, wherein the fan comprises an axial fan.

5. The apparatus of claim 1, wherein the flow straightener comprises a pattern of vanes.

6. The apparatus of claim 1, further comprising:
a further fan to create the air flow; and
a fan coupler to couple the fan to the further fan.

7. A printing system comprising:
a housing comprising an air inlet to receive cooler air and an air outlet to exhaust warmer air;
a printer component to heat the cooler air;
at least one fan to create an air flow between the air inlet and the air outlet;
a flow straightener to direct the air flow from the at least one fan; and
a silencer directly coupled to the flow straightener to reduce noise of the air flow.

8. The printing system of claim 7, wherein the silencer comprises a sound dampening, flame-retardant material.

9. The printing system of claim 7, wherein the flow straightener comprises a pattern of vanes aligned with the silencer.

10. The printing system of claim 7, wherein the printing system comprises a three-dimensional (3D) printing system.

11. The printing system of claim 7, wherein the printer component comprises a lamp assembly.

12. A method for moving air, the method comprising:
creating, via a fan, an air flow between an air inlet and an air outlet;
straightening the air flow directly after the fan; and
reducing the noise generated by the air flow directly after straightening the air flow.

13. The method of claim 12, wherein creating the air flow comprises creating the air flow via a plurality of fans.

14. The method of claim 12, further comprising:
cooling a component via the air flow.

15. The method of claim 14, wherein cooling the component comprises cooling a lamp assembly of a three-dimensional (3D) printing system.
